(19) United States
(12) Patent Application Publication
(10) Pub. No.: US 2013/0189877 A1
(43) Pub. Date: Jul. 25, 2013

(54) CABLE CONNECTOR

(71) Applicants: Rong-Qin Lan, New Taipei (TW); Li-Jun Xu, New Taipei (TW); Ming-Han Lin, New Taipei (TW)

(72) Inventors: Rong-Qin Lan, New Taipei (TW); Li-Jun Xu, New Taipei (TW); Ming-Han Lin, New Taipei (TW)

(21) Appl. No.: 13/354,307

(22) Filed: Jan. 19, 2012

(51) Int. Cl. H01R 13/648

(52) U.S. Cl. 439/607.27

(57) ABSTRACT

A cable connector connecting between a cable and a mated connector includes an insulating housing, a plurality of terminals disposed in the insulating housing, an inner shielding shell and an outer shielding shell surrounding the inner shielding shell. The insulating housing has a base portion and a tongue portion protruded forward from a front of the base portion. The insulating housing defines a plurality of passages concaved inward in periphery outer sides thereof and each extending along a front-to-rear direction. The inner shielding shell has a top plate, two end plates and a bottom plate which are interconnected to form an accommodating space thereamong for receiving the base portion therein. A plurality of contact strips are distributed along a front periphery of the inner shielding shell and restrained in the corresponding passages to electrically connect with the mated connector.

### BACKGROUND OF THE INVENTION

1. Field of the Invention

The present invention generally relates to a cable connector, and more particularly to a cable connector capable of effectively shielding electromagnetic interferences.

2. The Related Art

As is known to all, economy and technology have been developed faster and faster in recent years. In order to satisfy people's various needs, more and more electronic products are used in people's daily lives. Accordingly, a variety of connectors are widely used in the electronic products. A conventional cable connector connecting between a cable and a mated connector includes an insulating housing, a plurality of terminals and a shielding shell. The insulating housing has a base portion and a tongue portion protruding forward from a front of the base portion. The insulating housing defines a plurality of terminal grooves for receiving the terminals therein. The shielding shell surrounds the base portion. When the tongue portion of the cable connector is connected with the mated connector to realize an electrical connection between the cable connector and the mated connector, the shielding shell is away from the mated connector.

However, the electronic product will generate electromagnetic wave signals during a working process thereof so that are apt to interfere with electrical elements, such as the connector, assembled in the electronic product. Though the shielding shell of the above-mentioned cable connector has the performance of shielding the electromagnetic interferences, the shielding shell is away from the mated connector that makes it impossible for the mated connector to transmit the electromagnetic interferences outside. As a result, working reliability of the cable connector is affected.

### SUMMARY OF THE INVENTION

An object of the present invention is to provide a cable connector connecting between a cable and a mated connector. The cable connector includes an insulating housing, a plurality of terminals, an inner shielding shell and an outer shielding shell surrounding the inner shielding shell. The insulating housing has a base portion and a tongue portion protruded forward from a front of the base portion. The insulating housing defines two rows of terminal grooves of which each has a rear thereof penetrating through the base portion and a front thereof penetrating through a top or a bottom of the tongue portion. The insulating housing defines a plurality of passages concaved inward in periphery outer sides thereof and each extending along a front-to-rear direction. Each of the terminals is disposed in the terminal groove with a rear end thereof being fastened in the rear of the terminal groove to connect with the cable, and a front end thereof being exposed out from the top or the bottom of the tongue portion to electrically contact with the mated connector. The inner shielding shell has a top plate, two end plates and a bottom plate which are interconnected to form an accommodating space thereamong for receiving the base portion therein. A plurality of contact strips are distributed along a front periphery of the inner shielding shell and restrained in the corresponding passages to electrically connect with the mated connector.

As described above, the contact strips are restrained in the passages to electrically connect with the mated connector so as to make the cable connector effectively shield electromagnetic interferences by means of the inner shielding shell transmitting the electromagnetic interferences outside from the outer shielding shell. As a result, working reliability of the cable connector is assured.

### BRIEF DESCRIPTION OF THE DRAWINGS

The present invention will be apparent to those skilled in the art by reading the following description, with reference to the attached drawings, in which:

FIG. 1 is a perspective view of a cable connector in accordance with the present invention;

FIG. 2 is an exploded view of the cable connector of FIG. 1;

FIG. 3 is a perspective view of an insulating housing of the cable connector of FIG. 2; and

FIG. 4 is another perspective view of the insulating housing of the cable connector of FIG. 2.

### DETAILED DESCRIPTION OF THE PREFERRED EMBODIMENT

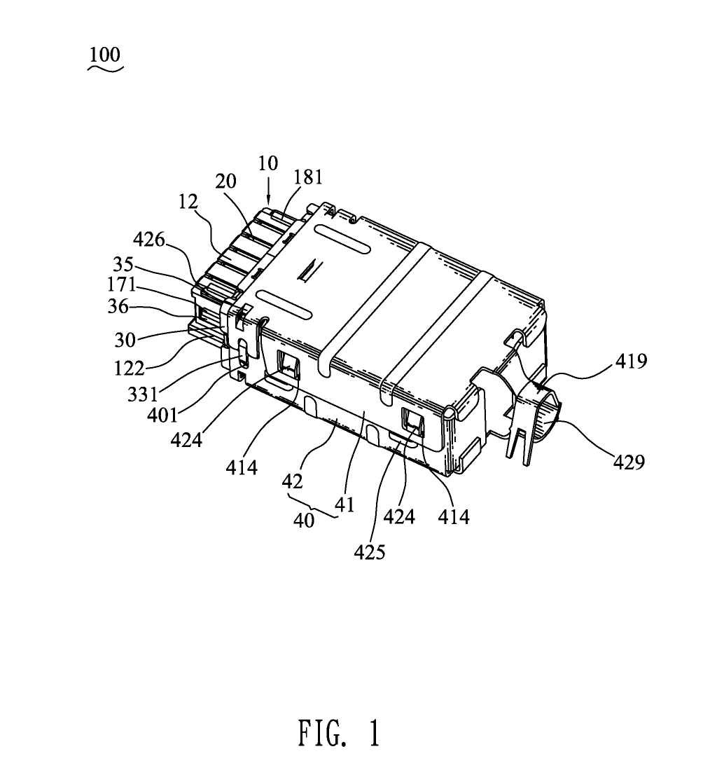

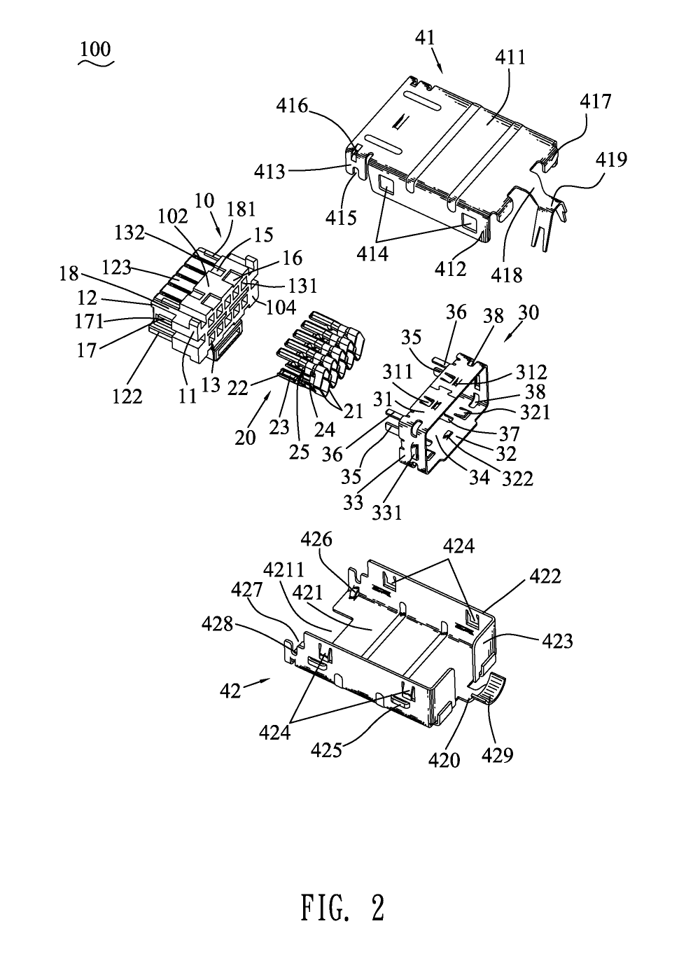

With reference to FIG. 1 and FIG. 2, a cable connector 100 in accordance with the present invention is shown. The cable connector 100 connecting between a cable (not shown) and a mated connector (not shown) includes an insulating housing 10, a plurality of terminals 20, an inner shielding shell 30 and an outer shielding shell 40.

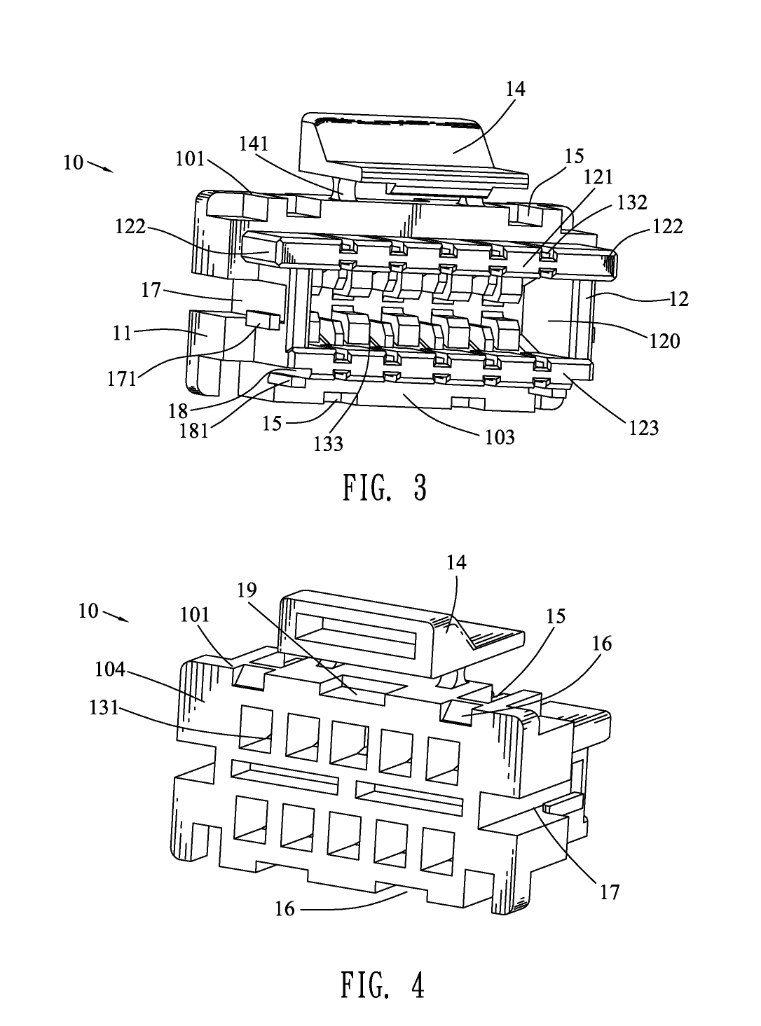

Referring to FIG. 2, FIG. 3 and FIG. 4, the insulating housing 10 has a base portion 11 and a tongue portion 12 of a substantially rectangular hollow shape protruded forward from a middle of a front surface 103 of the base portion 11. Accordingly, an inserting groove 120 is formed in a middle of the tongue portion 12 and has a front opened freely. Two opposite sides of a bottom wall 121 of the tongue portion 12 oppositely extend sideward to form two extending walls 122 which make the bottom wall 121 of the tongue portion 12 wider than a top wall 123 of the tongue portion 12 for effectively preventing a wrong operation when the tongue portion 12 is connected with the mated connector. The insulating housing 10 defines two rows of terminal grooves 13. Each row of the terminal grooves 13 are arranged at regular intervals along a transverse direction of the insulating housing 10. Each terminal groove 13 includes a rectangular receiving groove 131 extending along a front-to-rear direction to penetrate through a rear surface 104 of the base portion 11, a fastening groove 132 extending along the front-to-rear direction into the corresponding top wall 123 or the bottom wall 121 of the tongue portion 12 from an outer end of a front of the receiving groove 131 with a middle thereof vertically penetrating through the top wall 123 or the bottom wall 121, and a U-shaped holding groove 133 extending along the front-to-rear direction to penetrate through a front of the base portion 11, and connecting with the front of the receiving groove 131 and a rear of the fastening groove 132. The fastening groove 132 and the holding groove 133 communicate with the inserting groove 120.

Referring to FIG. 2, FIG. 3 and FIG. 4 again, a fastening board 14 is located under the base portion 11 and has two resisting pillars 141 protruding towards a bottom surface 101 of the base portion 11 from a middle of a top face of the fastening board 14 and connecting with the bottom surface 101 of the base portion 11. The bottom surface 101 and a top surface 102 of the base portion 11 respectively define two first recesses 15, and two second recesses 16 in alignment with the two first recesses 15 respectively. Each of the first recesses 15 extends along the front-to-rear direction to pass through the front surface 103 and each of the second recesses 16 extends along the front-to-rear direction to pass through the rear surface 104. A middle of a rear of the bottom surface 101 is recessed inward to form a third recess 19 extending along the front-to-rear direction to pass through the rear surface 104. The insulating housing 10 defines two first passages 17 concaved inward in two opposite side faces thereof and extending along the front-to-rear direction to penetrate through the rear surface 104 of the base portion 11, and two second passages 18 concaved inward in two opposite sides of a top thereof and extending along the front-to-rear direction to penetrate through the rear surface 104 of the base portion 11. A first limiting block 171 protrudes in a front of each first passage 17 and is paced from an innermost wall of the corresponding first passage 17. A second limiting block 181 protrudes in a front of each second passage 18 and is paced from an innermost wall of the corresponding second passage 18.

Referring to FIG. 2, each of the terminals 20 has two first fastening arms 21 connected with each other to show a V shape from a rear view. A front of a junction of the two fastening arms 21 extends forward to form a first contact arm 22. A middle of a front of the first contact arm 22 is folded up towards the first contact arm 22 to form a second contact arm 23. Two second fastening arms 24 are inclined oppositely from two sides of the first contact arm 22, and located in front of the two first fastening arms 21. Two middles of the two sides of the first contact arm 22 are bent towards each other to form two third fastening arms 25 located in a rear of the second contact arm 23 and in front of the two second fastening arms 24.

Referring to FIG. 1 and FIG. 2, the inner shielding shell 30 has a top plate 31, two end plates 33 and a bottom plate 32 which are interconnected to form an accommodating space 34 thereamong. Two middles of two fronts of the two end plates 33 bend inward and then extend forward to form two first contact strips 35. Two portions of a front of the top plate 31 bend inward and then extend forward to form two second contact strips 36. Two portions of a front of the bottom plate 32 are recessed inward to define two notches 37 spaced from each other. Two portions of the front of the top plate 31 are punched inward to form two first buckling portions 311 projecting into the accommodating space 34. Two portions of a rear of the top plate 31 are concaved inward to form two first convex portions 312 projecting into the accommodating space 34. The first convex portions 312 are in alignment with the first buckling portions 311, respectively. Two portions of the bottom plate 32 are punched inward to form two second buckling portions 321 projecting into the accommodating space 34. A middle of the bottom plate 32 is concaved inward to form a second convex portion 322 located between the two second buckling portions 321 and projecting into the accommodating space 34. Two outer surfaces of the two end plates 33 protrude oppositely to form two buckling blocks 331. Two middles of two junctions between the top plate 31 and the two end plates 33, and two middles of two junctions between the bottom plate 32 and the two end plates 33 are cut off to define four buckling holes 38.

Referring to FIG. 1 and FIG. 2 again, the outer shielding shell 40 includes an upper shielding shell 41 and a lower shielding shell 42. The upper shielding shell 41 has a rectangular first base plate 411. Two rears of two opposite sides of the first base plate 411 bend downward to form two first lateral plates 412. Two fronts of the two opposite sides of the first base plate 411 bend downward to form two bending plates 413. Each first lateral plate 412 defines two fastening holes 414. A middle of a bottom of the bending plate 413 is concaved inward to form a first buckling groove 415. A front of a junction of each bending plate 413 and the first base plate 411 is punched inward to form a first wedging portion 416 hung in the air. Two ends of a rear edge of the first base plate 411 bend downward to form two spaced blocking plates 417. A middle of the rear end edge of the first base plate 411 extends rearward and then is inclined downward and rearward to form a first connecting arm 418 of which a free end is connected with a first clamping piece 419.

The lower shielding shell 42 has a rectangular second base plate 421. A middle of a front of the second base plate 421 is cut off to define a mouth 4211. Two opposite sides of the second base plate 421 bend upward to form two second lateral plates 422. Two opposite ends of a rear edge of the second base plate 421 bend upward to form two rear plates 423 connecting with the two second lateral plates 422, respectively. Two portions of an upper portion of each second lateral plate 422 are punched outward to form two buckling pieces 424, and two portions of a lower portion of each second lateral plate 422 protrude outward to form two blocking portions 425. A front of a junction of each second lateral plate 422 and the second base plate 421 is punched inward to form a second wedging portion 426 hung in the air. Two tops of two fronts of the two second lateral plates 422 are cut off to define two gaps 427. A middle of a bottom inner edge of the gap 427 is concaved inward to form a second buckling groove 428. A middle of the rear end of the second base plate 421 extends rearward, and then is inclined rearward and upward to form a second connecting arm 420 of which a free end is connected with a second clamping piece 429.

Referring to FIGS. 1-4, when the cable connector 100 is assembled, the terminals 20 are disposed in the terminal grooves 13 with the first fastening arms 21 being received in the receiving grooves 131, the second fastening arms 24 being received in the holding grooves 133, and the third fastening arms 25 being blocked by the front of the base portion 11. The first contact arms 22 and the second contact arms 23 are fastened in the fastening grooves 132 with middles of the first and second contact arms 22, 23 being exposed from the middles of the fastening grooves 132 to electrically contact with the mated connector. The cable is fastened in the first fastening arms 21, the second fastening arms 24, and the third fastening arms 25 to electrically connect with the terminals 20 of the cable connector 100. The base portion 11 is inserted into the accommodating space 34 of the inner shielding shell 30 from a rear of the inner shielding shell 30 with the first buckling portions 311 and the second buckling portions 321 being buckled in the first recesses 15 through the second recesses 16, the first convex portions 312 being blocked in the second recesses 16, and the second convex portion 322 being blocked in the third recess 19 to fasten the inner shielding shell 30 to the base portion 11 firmly. The first contact strips 35 are restrained in the first passages 17 by the first limiting blocks 171, and the second contact strips 36 are restrained in the second passages 18 by the second limiting blocks 181 to make the first contact strips 35 and the second contact strips 36 electrically connect with the mated connector. The resisting pillars 141 are clipped in the notches 37 to locate the fastening board 14 under the inner shielding shell 30.

Then the outer shielding shell 40 surrounds the inner shielding shell 30. Specifically, position the lower shielding shell 42 under the inner shielding shell 30 with the second wedging portion 426 being buckled in the buckling holes 38 formed between the bottom plate 32 and the two end plates 33 and bottoms of the buckling blocks 331 being inserted into the second buckling grooves 428 to fasten the lower shielding shell 42 to the inner shielding shell 30 simply and reliably. The fastening board 14 is located in the mouth 4211. Next, position the upper shielding shell 41 on the inner shielding shell 30 with the first wedging portion 416 being buckled in the buckling holes 38 formed between the top plate 31 and the two end plates 33 and tops of the buckling blocks 331 being inserted into the first buckling grooves 415 to fasten the upper shielding shell 41 to the inner shielding shell 30 simply and reliably. In the meanwhile, the upper shielding shell 41 is engaged with the lower shielding shell 42 with the bottom of the bending plate 413 corresponding to the bottom inner sidewall of the gap 427 to integrate the first buckling groove 415 together with the second buckling groove 428 to define a buckling groove 401 for buckling the buckling block 331 therein, and the two buckling pieces 424 being buckled in the two fastening holes 414 so as to make the outer shielding shell 40 fasten to the inner shielding shell 30 firmly and reliably. Bottoms of the two first lateral plates 412 are located on the blocking portions 425 and the two blocking plates 417 are positioned on the two rear plates 423 to locate the upper shielding shell 41 on the lower shielding shell 42 steadily. So that the cable connector 100 effectively shields electromagnetic interferences by means of the inner shielding shell 30 transmitting the electromagnetic interferences outside from the outer shielding shell 40. The first clamping piece 419 is matched with the second clamping piece 429 to clamp the cable to the outer shielding shell 40 reliably.

As described above, the first contact strips 35 and the second contact strips 36 are restrained in the first passages 17 and the second passages 18 to electrically connect with the mated connector so as to make the cable connector 100 effectively shield the electromagnetic interferences by means of the inner shielding shell 30 transmitting the electromagnetic interferences outside from the outer shielding shell 40. Furthermore, the second wedging portions 426 and the first wedging portions 416 are buckled in the buckling holes 38 to respectively fasten the lower shielding shell 42 and the upper shielding shell 41 to the inner shielding shell 30 simply and reliably. In addition, the two opposite sides of the bottom wall 121 of the tongue portion 12 oppositely extend sideward to form the two extending walls 122 which make the bottom wall 121 of the tongue portion 12 wider than the top wall 123 of the tongue portion 12 for effectively preventing the wrong operation when the tongue portion 12 is connected with the mated connector. As a result, working reliability of the cable connector 100 is assured.

What is claimed is:

1. A cable connector connecting between a cable and a mated connector, comprising:
an insulating housing having a base portion and a tongue portion protruded forward from a front of the base portion, the insulating housing defining two rows of terminal grooves of which each has a rear thereof penetrating through the base portion and a front thereof penetrating through a top or a bottom of the tongue portion, the insulating housing defining a plurality of passages concaved inward in periphery outer sides thereof and each extending along a front-to-rear direction;
a plurality of terminals each disposed in the terminal groove with a rear end thereof being fastened in the rear of the terminal groove to connect with the cable, and a front end thereof being exposed out from the top or the bottom of the tongue portion to electrically contact with the mated connector;
an inner shielding shell having a top plate, two end plates and a bottom plate which are interconnected to form an accommodating space thereamong for receiving the base portion therein, a plurality of contact strips being distributed along a front periphery of the inner shielding shell and restrained in the corresponding passages to electrically connect with the mated connector; and
an outer shielding shell surrounding the inner shielding shell.

2. The cable connector as claimed in claim 1, wherein a limiting block protrudes in a front of each passage and is paced from an innermost wall of the corresponding passage for restraining the contact strip in the passage.

3. The cable connector as claimed in claim 2, wherein the contact strips are designated as two first contact strips bending inward and extending forward from two fronts of the two end plates, and two second contact strips bending inward and then extending forward from two portions of a front of the top plate, the passages are designated as two first passages concaved inward in two opposite side faces of the insulating housing and penetrating through a rear of the insulating housing for restraining the first contact strips therein, and two second passages concaved inward in two opposite sides of a top of the insulating housing and penetrating through the rear of the insulating housing for restraining the second contact strips therein.

4. The cable connector as claimed in claim 1, wherein the outer shielding shell includes an upper shielding shell and a lower shielding shell, the upper shielding shell has a first base plate and two bending plates bending downward from two opposite sides of a front of the first base plate, a junction of each bending plate and the first base plate defines a first wedging portion, the lower shielding shell has a second base plate and two second lateral plates, a junction of each second lateral plate and the second base plate defines a second wedging portion, two junctions between the top plate and the two end plates of the inner shielding shell, and two junctions between the bottom plate and the two end plates define a plurality of buckling holes for buckling the first wedging portions and the second wedging portions therein.

5. The cable connector as claimed in claim 4, wherein the upper shielding shell has two first lateral plates of which each defines two fastening holes, a bottom of each bending plate is concaved upward to form a first buckling groove, each second lateral plate defines two buckling pieces buckled in the two fastening holes, a top of a front of each second lateral plate defines a gap of which a bottom inner edge is concaved downward to form a second buckling groove, the second buckling grooves are matched with the first buckling grooves to together define two buckling grooves for buckling two buckling blocks protruded oppositely on two outer surfaces of the two end plates of the inner shielding shell.

6. The cable connector as claimed in claim 4, wherein two ends of a rear edge of the second base plate bend upward to form two rear plates respectively connecting with the two second lateral plates, a lower portion of each second lateral plate protrudes outward to form two blocking portions for propping bottoms of the two first lateral plates, two ends of a rear edge of the first base plate bend downward to form two spaced blocking plates positioned on the two rear plates to locate the upper shielding shell on the lower shielding shell steadily.

7. The cable connector as claimed in claim 1, wherein two opposite sides of the bottom of the tongue portion oppositely extend sideward to form two extending walls which make the bottom of the tongue portion wider than the top of the tongue portion.
